(19) United States
(12) Patent Application Publication
(10) Pub. No.: US 2022/0129861 A1
(43) Pub. Date: Apr. 28, 2022

(54) DYNAMIC MAINTENANCE SCHEDULING FOR VEHICLES

(71) Applicant: ANI TECHNOLOGIES PRIVATE LIMITED, Bengaluru (IN)

(72) Inventors: HITESH HINDUJA, Thane (IN); SMRUTI CHOURASIA, Jabalpur (IN); HRISHIKESH BHARADWAJ CHAKRAPANI, Bangalore (IN); KRISHNA KOUSHIK VSR, Nellore (IN); GAURAV AGARWAL, Bangalore (IN)

(73) Assignee: ANI TECHNOLOGIES PRIVATE LIMITED, Bengaluru (IN)

(21) Appl. No.: 17/139,960

(22) Filed: Dec. 31, 2020

(30) Foreign Application Priority Data
Oct. 28, 2020 (IN) 202041047079

(51) Int. Cl. G06Q 10/00; G06N 20/00

(52) U.S. Cl. CPC G06Q 10/20; G06N 20/00

(57) ABSTRACT

A method for dynamic maintenance scheduling includes receiving, by a server, first maintenance data, first vehicle data, first booking data, and a plurality of maintenance plans associated with a plurality of vehicles. The plurality of maintenance plans is indicative of historical scheduled maintenance sessions of a corresponding vehicle of the plurality of vehicles. The method includes determination of a plurality of features and a corresponding plurality of feature values for each of the plurality of vehicles. The method includes training a prediction model based on the plurality of features and the corresponding feature values. The method includes determination of a maintenance criterion for a target vehicle based on the trained prediction model and a target dataset associated with the target vehicle. The maintenance criterion indicates an odometer reading range of the target vehicle during which a scheduled maintenance of the target vehicle is to be performed.

### CROSS-RELATED APPLICATIONS

This application claims priority of Indian Non-Provisional Application No. 202041047079, filed Oct. 28, 2020, the contents of which are incorporated herein by reference.

### FIELD

Various embodiments of the disclosure relate generally to predictive maintenance. More specifically, various embodiments of the disclosure relate to methods and systems for dynamic maintenance scheduling for vehicles.

### BACKGROUND

Generally, every vehicle has a corresponding static maintenance plan given by its manufacturer for scheduled maintenance. Vehicles having identical makes and models may have identical maintenance plans, which are expected to be adhered to by vehicle owners or drivers. A maintenance plan is typically indicative of scheduled maintenance sessions a vehicle should undergo at different odometer readings.

However, such static maintenance plans may not be effective, as each vehicle may be driven in different geographical locations by different drivers and may be exposed to different environmental and physical conditions. For example, as per manufacturer's guidelines, two vehicles (i.e., first and second vehicles) having identical make and model may have to undergo a scheduled maintenance at an odometer reading of 10,000 kilometers (km). For the first vehicle, the scheduled maintenance at 10,000 km may be too late as the first vehicle may not be well taken care of and may have been exposed to rash driving. Further, for the second vehicle, the scheduled maintenance at 10,000 km may be too early as the second vehicle may be well maintained and attentively driven. Thus, a health of the first vehicle may have already deteriorated by the time the first vehicle undergoes the scheduled maintenance at 10,000 km. As a result, the first vehicle may require additional resources, cost, time, efforts, and downtime for proper maintenance. On the contrary, the second vehicle may have to undergo unnecessary downtime for scheduled maintenance at 10,000 km.

In light of the foregoing, there exists a need for a technical and reliable solution that overcomes the above-mentioned problems and allows for accurate and efficient scheduling of maintenance for vehicles.

### SUMMARY

Methods for dynamic maintenance scheduling for vehicles are provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1A is a block diagram that illustrates a system environment for dynamic maintenance scheduling for vehicles, in accordance with an exemplary embodiment of the disclosure;

FIG. 1B is a block diagram that illustrates another system environment for dynamic maintenance scheduling for vehicles, in accordance with another exemplary embodiment of the disclosure;

FIG. 2A is a schematic diagram that illustrates an exemplary scenario for training a prediction model for dynamic maintenance scheduling for vehicles, in accordance with an exemplary embodiment of the disclosure;

FIG. 2B is a schematic diagram that illustrates an exemplary scenario for scheduling dynamic maintenance sessions for a vehicle using a trained prediction model, in accordance with an exemplary embodiment of the disclosure;

FIG. 3 is a block diagram that illustrates a system architecture of a computer system for dynamic maintenance scheduling of a vehicle, in accordance with an exemplary embodiment of the disclosure; and

FIG. 4 is a flowchart that illustrates a method for dynamic maintenance scheduling for vehicles, in accordance with an exemplary embodiment of the disclosure.

### DETAILED DESCRIPTION

Certain embodiments of the disclosure may be found in the disclosed systems and methods for dynamic maintenance scheduling for vehicles. Exemplary aspects of the disclosure provide methods for dynamic scheduling of maintenance sessions for vehicles. The methods include various operations that are executed by a server (for example, an application server) to perform dynamic maintenance scheduling for a vehicle. In an embodiment, the server is configured to receive first maintenance data, first vehicle data, first booking data, and a plurality of maintenance plans associated with a plurality of vehicles. Each of the plurality of maintenance plans is indicative of one or more historical scheduled maintenance sessions of a corresponding vehicle of the plurality of vehicles. The server is further configured to determine a plurality of features and a corresponding plurality of feature values for each of the plurality of vehicles based on the first maintenance data, the first vehicle data, the first booking data, and the plurality of maintenance plans. The server is further configured to train a prediction model based on the plurality of features and the corresponding plurality of feature values. The server is further configured to determine a maintenance criterion for a target vehicle based on the trained prediction model and a target dataset associated with the target vehicle. The target dataset includes second maintenance data, second vehicle data, and second booking data associated with the target vehicle. The maintenance criterion indicates an odometer reading range of the target vehicle during which a scheduled maintenance of the target vehicle is to be performed.

In an embodiment, the server is further configured to generate a scheduled maintenance ticket for the target vehicle based on a real-time odometer reading of the target vehicle and the determined maintenance criterion. The scheduled maintenance ticket is indicative of at least one of a date of the scheduled maintenance of the target vehicle, a time of the scheduled maintenance, a workshop name for the scheduled maintenance, and a workshop address for the scheduled maintenance.

In another embodiment, the server is further configured to communicate, to a driver device associated with the target vehicle, the scheduled maintenance ticket to notify a driver of the target vehicle regarding the scheduled maintenance.

In another embodiment, the server is further configured to validate the trained prediction model based on a test vehicle, a test dataset associated with the test vehicle, and a historic maintenance plan associated with the test vehicle.

In an embodiment, the plurality of features include a mean time between consecutive failures of a vehicle. The plurality of features further include at least two or more of a count of non-scheduled maintenance sessions of a vehicle, a count of repairs of a vehicle, a count of major accidents of a vehicle, or a unit distance travelled by a vehicle between consecutive maintenance sessions in past. The plurality of features further include at least two or more of a count of non-scheduled repairs of a vehicle, a maintenance cost of a vehicle, a cost incurred due to accidents of a vehicle, a repair downtime of a vehicle, an average cost incurred for historical maintenance sessions of a vehicle, a frequency of maintenance sessions of a vehicle, or a deviation in a frequency of maintenance sessions of a vehicle. The plurality of features further include a cost per unit distance forecasted for one or more components of a vehicle and an asset health index of a vehicle. The plurality of features further include at least two or more of a count of dormant days of a vehicle, a count of active days of a vehicle, or a deviation in a count of active days between consecutive scheduled maintenance sessions of a vehicle. The plurality of features further include at least two or more of a dry run distance travelled by a vehicle, a trip run distance travelled by a vehicle, an excess run distance travelled by a vehicle, a total distance travelled per day by a vehicle, or an average total distance travelled per day by a vehicle. The plurality of features further include at least two or more of a vehicle make, a vehicle model, a region of operation of a vehicle, an age of a vehicle, a fuel type of a vehicle, a count of unique drivers of a vehicle, or an odometer reading of a vehicle.

The methods and systems of the disclosure provide a solution for ensuring timely maintenance of a vehicle. The disclosed methods and systems also prevent unnecessary maintenance of the vehicle. Therefore, the disclosed methods and systems ensure near-optimal utilization of time, cost, effort, and resources required for maintenance of the vehicle. Since the disclosed methods and systems allow for scheduling the maintenance of the vehicle based on real-time performance and health of the vehicle, the disclosed methods and systems prevent the vehicle from unexpected break downs.

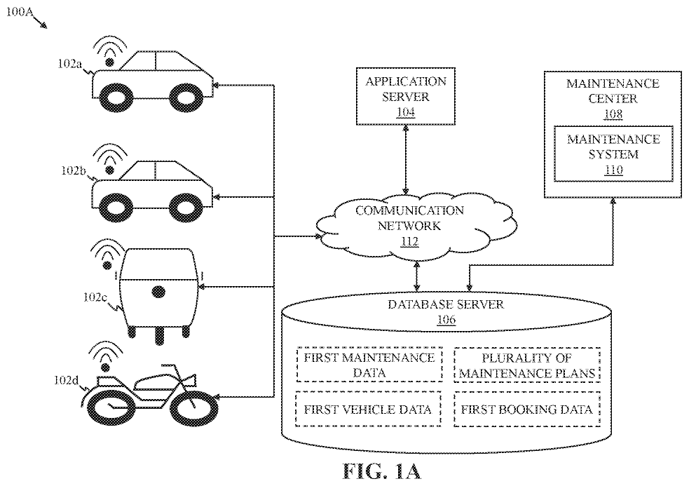

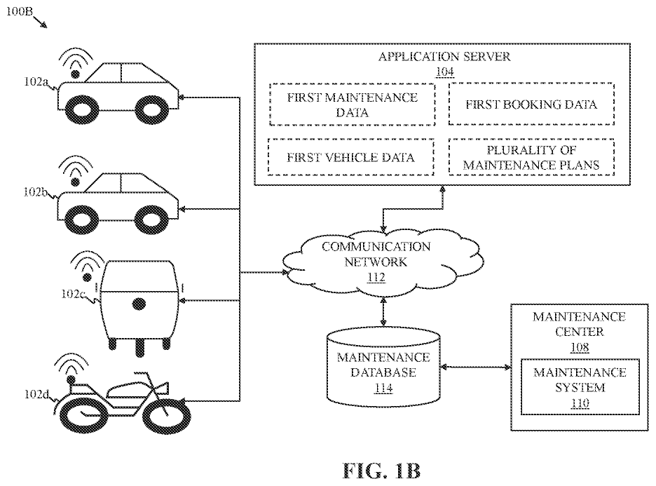

FIG. 1A is a block diagram that illustrates a system environment 100A for dynamic maintenance scheduling for vehicles, in accordance with an exemplary embodiment of the disclosure. The system environment 100A includes a plurality of vehicles 102a-102d, an application server 104, a database server 106, a maintenance center 108 having a maintenance system 110, and a communication network 112. Examples of the communication network 112 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities (such as the plurality of vehicles 102a-102d, the application server 104, the database server 106, and the maintenance system 110) in the system environment 100A may be communicatively coupled to the communication network 112 in accordance with various wired and wireless communication protocols, such as Transmission Control Protocol and Internet Protocol (TCP/IP), User Datagram Protocol (UDP), Long Term Evolution (LTE) communication protocols, or any combination thereof. In one example, the plurality of vehicles 102a-102d may be communicatively coupled to the communication network 112 via one of corresponding telematics devices, corresponding on-board diagnostics devices (OBDs), corresponding driver devices, or a connected car network handled by a third-party server.

Each vehicle 102a-102d is a mode of transport and may include suitable logic, circuitry, interfaces and/or code, executable by the circuitry, that may be configured to control and perform one or more operations with or without a driving assistance. In an embodiment, the plurality of vehicles 102a-102d may be associated with a transportation service provider (e.g., a cab service provider, an on-demand transportation service provider, or the like) to cater to travelling requirements of various passengers. Examples of the plurality of vehicles 102a-102d may include, but are not limited to, an automobile, a bus, a car, an auto rickshaw, and a bike. For the sake of brevity, the plurality of vehicles 102a-102d are shown to include two four-wheeler vehicles 102a and 102b, a three-wheeler vehicle 102c, and a two-wheeler vehicle 102d. The plurality of vehicles 102a-102d may have different configurations and may have been exposed to different environmental, physical, and driving conditions. As a result, the plurality of vehicles 102a-102d may have different health and performance statistics, and hence may require maintenance at different time intervals. Further, the plurality of vehicles may undergo scheduled maintenance sessions as well as non-scheduled maintenance sessions in order to maintain a good health.

A scheduled maintenance session may refer to a pre-planned repair and maintenance of a vehicle for maintaining good health and performance. The scheduled maintenance session may be recommended by one of a manufacturer of the vehicle, a driver of the vehicle, and a transportation service provider associated with the vehicle. The scheduled maintenance session may include inspection of one or more parameters or components including oil and an oil filter, an air filter, a fuel filter, a battery, brake fluid, brake pads, brake rotors, coolant, transmission fluid, hoses, power steering fluid, spark plugs, an ignition system, a timing belt, or the like.

An unscheduled maintenance session of a vehicle may refer to an unplanned inspection, adjustment, repair, removal, disassembly, cleaning, or replacement of one or more components of the vehicle to correct an unanticipated issue with the vehicle. The unscheduled maintenance session may not have been budgeted for in the budget for repair and maintenance of the vehicle. The unscheduled maintenance session may be required due to unforeseen circumstances that would not reasonably be expected to be scheduled and budgeted.

The maintenance center 108 is an entity (for example, a place, an organization, or the like) that provides a platform for physical inspection of one or more components and the health and performance of each vehicle 102a-102d. The plurality of vehicles 102a-102d may be examined at the maintenance center 108 on a regular basis such as weekly, monthly, annually, or as mandated by corresponding vehicle manufacturers. The maintenance center 108 may include the maintenance system 110. The maintenance system 110 may include suitable logic, circuitry, interfaces, and/or code, that may be configured to control and execute one or more operations for performing troubleshooting and maintenance of the one or more components of the plurality of vehicles 102a-102d. The maintenance system 110 may be configured to record maintenance data (such as service and repair data) of each vehicle 102a-102d. The maintenance system 110 may be further configured to perform operations for storing the maintenance data associated with the plurality of vehicles 102a-102d in the database server 106. The maintenance system 110 may be configured to record the maintenance data, during each scheduled or non-scheduled maintenance session of each vehicle 102a-102d in the database server 106. The maintenance data may indicate one or more parameters associated with repair and maintenance of each vehicle 102a-102d. The maintenance data of a vehicle may include information pertaining to a time of visit of the vehicle at the maintenance center, a condition of the vehicle when the vehicle came for maintenance, a condition of the vehicle after the maintenance, an issue associated with the vehicle, one or more maintenance and repair actions associated with the vehicle, or the like. In other words, the maintenance data of the plurality of vehicles 102a-102d may be indicative of a pre-maintenance condition of each vehicle 102a-102d, a post-maintenance condition of each vehicle 102a-102d, and repair actions taken during a maintenance session of each vehicle 102a-102d. The maintenance data of the plurality of vehicles 102a-102d may be further indicative of information pertaining to a mean time between consecutive failures of each vehicle 102a-102d, a count of non-scheduled maintenance sessions of each vehicle 102a-102d, a count of repairs of each vehicle 102a-102d, a count of major accidents of each vehicle 102a-102d, and a unit distance travelled by each vehicle 102a-102d between consecutive maintenance sessions in the past. The maintenance data of the plurality of vehicles 102a-102d may be further indicative of information pertaining to a unit distance travelled by each vehicle 102a-102d after a non-scheduled maintenance session, a count of non-scheduled repairs of each vehicle 102a-102d, a maintenance cost of each vehicle 102a-102d, and a cost incurred due to accidents for each vehicle 102a-102d. The maintenance data of the plurality of vehicles 102a-102d may be further indicative of information pertaining to a repair downtime of each vehicle 102a-102d, an average cost incurred for historical maintenance sessions of each vehicle 102a-102d, a frequency of maintenance sessions of each vehicle 102a-102d, and a deviation in a frequency of maintenance sessions of each vehicle 102a-102d. In an embodiment, the maintenance data of the plurality of vehicles 102a-102d is collectively referred to as “first maintenance data”.

The database server 106 may include suitable logic, circuitry, interfaces, and/or code, executable by the circuitry, that may be configured to perform one or more operations for collecting and storing the first maintenance data, first booking data, first vehicle data, and a plurality of maintenance plans associated with the plurality of vehicles 102a-102d. The database server 106 may collect the first maintenance data, the first booking data, the first vehicle data, and the plurality of maintenance plans associated with the plurality of vehicles 102a-102d from each vehicle 102a-102d and the maintenance system 110. Examples of the database server 106 may include a cloud-based database, a local database, a distributed database, a database management system (DBMS), or the like.

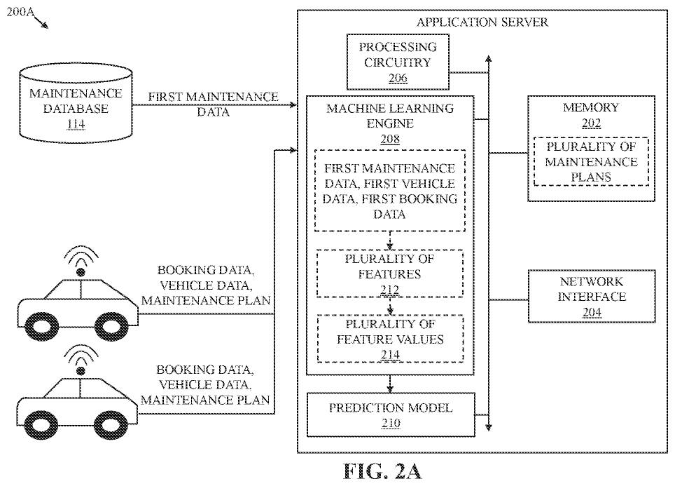

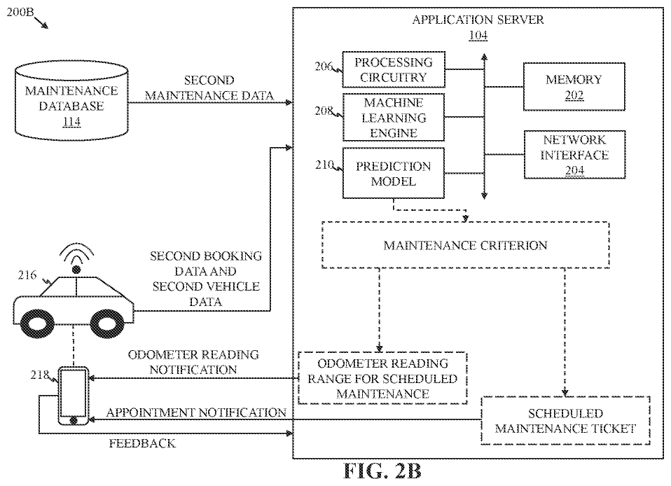

Booking data of a vehicle includes various parameters that indicate day-to-day operations of the vehicle for catering to travel demand of passengers. The vehicle may be booked by one or more passengers for multiple rides. In other words, booking data encompasses data associated with the vehicle when the vehicle is being driven to cater to travel needs of the one or more passengers. The booking data of the plurality of vehicles 102a-102d may be indicative of information pertaining to a dry run distance travelled by each vehicle 102a-102d, a trip distance travelled by each vehicle 102a-102d, and an excess distance travelled by each vehicle 102a-102d. The booking data of the plurality of vehicles 102a-102d may be further indicative of information pertaining to a total distance travelled per day by each vehicle 102a-102d and an average total distance travelled per day by each vehicle 102a-102d. In one embodiment, the database server 106 may receive real-time booking data from a driver device (as shown in FIG. 2B) associated with each vehicle 102a-102d. The booking data of the plurality of vehicles 102a-102d is collectively referred to as the first booking data. Examples of the driver device may include a mobile phone, a smartphone, a laptop, a tablet, a phablet, or the like. In another embodiment, the database server 106 may receive the first booking data from the transportation service provider associated with the plurality of vehicles 102a-102d.

The booking data may be further indicative of utilization and inactivity period of each vehicle 102a-102d. For example, the booking data of a vehicle may indicate whether the vehicle is over-utilized, under-utilized, or as expected utilized. Over-utilization may refer to a situation where a distance driven per day by a vehicle is greater than a distance that is expected to be driven per day by the vehicle as per manufacturer's or transportation service provider recommendation. Over-utilization of the vehicle may negatively impact the health of the vehicle and may warrant unnecessary scheduled maintenances. For example, during day, the vehicle 102a may be driven by a driver A and during night another driver B might be driving the vehicle 102a. Therefore, the vehicle 102a is being driven round the clock, hence, the booking data associated with the vehicle 102a may indicate that the vehicle 102a is over-utilized. Therefore, the vehicle 102a may be suffering from numerous wear and tear and over-heating issues. Under-utilization may refer to a situation where a distance driven by a vehicle in a time-period is less than a minimum distance that is expected to be driven in the time-period as per manufacturer's or transportation service provider recommendation. In an example, the manufacturer of the vehicle 102a may have recommended to drive the vehicle 102a for at least for 1,000 kilometers during a first month of its use. However, during the first month of use, the vehicle 102a may be driven by the driver for 50 kilometers every alternate day. Therefore, by end of the first month of use, the vehicle 102a may have been driven for only 700 kilometers (14*50=700). Therefore, the vehicle 102a may be under-utilized. Further, under-utilization of the vehicle 102a may lead to rusting, battery decay, and other performance issues.

Vehicle data of a vehicle includes various parameters which are specific to the vehicle. For example, the vehicle data of the plurality of vehicles 102a-102d may be indicative of information pertaining to a make of each vehicle 102a-102d, a model of each vehicle 102a-102d, a region of operation of each vehicle 102a-102d, an age of each vehicle 102a-102d, a count of unique drivers of each vehicle 102a-102d, a fuel type of each vehicle 102a-102d, and an odometer reading of each vehicle 102a-102d. The vehicle data of the plurality of vehicles 102a-102d may be further indicative of information pertaining to a count of dormant days of each vehicle 102a-102d, a count of active days of each vehicle 102a-102d, a deviation in a count of active days between consecutive scheduled maintenance sessions of each vehicle 102a-102d, a cost per unit distance forecasted for one or more components of each vehicle 102a-102d, and an asset health index of each vehicle 102a-102d. In one embodiment, the database server 106 may receive the vehicle data from a corresponding driver device, the telematics device, or the corresponding OBD associated with each vehicle 102a-102d. The vehicle data of the plurality of vehicles 102a-102d is collectively referred to as the first vehicle data. In another embodiment, the database server 106 may receive the first vehicle data from the transportation service provider associated with the plurality of vehicles 102a-102d.

A maintenance plan of a vehicle includes a list of historical scheduled maintenance sessions that were performed in the past for the vehicle and a list of future scheduled maintenance sessions that are planned to be performed for the vehicle. Each scheduled maintenance session in the list may be scheduled based on a distance travelled by the vehicle, i.e., a real-time odometer reading of the vehicle. In an example, a maintenance plan of a vehicle having a current odometer reading as 30,000 km may indicate first through third scheduled maintenance sessions. The first maintenance session may be a historical scheduled maintenance session that the vehicle underwent at an odometer reading of 25,000 kilometers (kms). The second maintenance session may be scheduled at an odometer reading of 35,000 km and the third maintenance session may be scheduled at an odometer reading of 50,000 kms. In another example, a vehicle, which is two years old, may have underwent four scheduled maintenance sessions as per its maintenance plan. Further, multiple maintenance sessions may be scheduled for the vehicle in future as per the corresponding maintenance plan. In one embodiment, the database server 106 may receive the maintenance plan of each vehicle 102a-102d from the corresponding driver device, the telematics device, or the OBD associated with each vehicle 102a-102d. The maintenance plans of the plurality of vehicles 102a-102d are collectively referred to as the plurality of maintenance plans. In another embodiment, the database server 106 may receive the plurality of maintenance plans from the transportation service provider associated with the plurality of vehicles 102a-102d. Hereinafter, the terms “maintenance plans” and “plurality of maintenance plans” are used interchangeably.

The application server 104 may include suitable logic, circuitry, interfaces, and/or code, executable by the circuitry, that may be configured to perform one or more operations for dynamic scheduling of maintenance for vehicles (for example, any of the plurality of vehicles 102a-102d or other vehicles). The application server 104 may be configured to communicate with the database server 106, the maintenance system 110, and the driver devices associated with the plurality of vehicles 102a-102d via the communication network 112. Examples of the application server 104 may include a cloud-based server, a local server, a group of centralized servers, a group of distributed servers, or the like. The application server 104 may be configured to operate in two phases such as a training phase and an implementation (or execution) phase. The application server 104 may operate in the training phase to train a prediction model (as shown in FIG. 2A) for dynamic maintenance scheduling. After the prediction model is trained, the application server 104 may operate in the implementation phase. Various components of the application server 104 and operations performed by the application server 104 are explained in detail in conjunction with FIGS. 2A and 2B.

In operation, during the training phase, the application server 104 may be configured to receive the first maintenance data, the first booking data, the first vehicle data, and the maintenance plans of the plurality of vehicles 102a-102d from the database server 106, the maintenance system 110, the plurality of vehicles 102a-102d, and/or the transportation service provider associated with the plurality of vehicles 102a-102d. The application server 104 may be further configured to determine a plurality of features and a corresponding plurality of feature values based on the first maintenance data, the first booking data, the first vehicle data, and the maintenance plans. The plurality of features are direct or indirect indicators of a schedule maintenance requirement of a vehicle. The processes of determining the plurality of features and the corresponding plurality of feature values, and training the prediction model are described in detail in conjunction with FIG. 2A.

The application server 104 may be further configured to train the prediction model based on the plurality of features and the plurality of feature values. Based on the training data (i.e., the plurality of features and the corresponding plurality of feature values for the plurality of vehicles 102a-102d), the prediction model may learn a correlation between vehicle performance and health and a requirement of scheduled and non-scheduled maintenances by vehicles. In an embodiment, the application server 104 may be further configured to validate the trained prediction model based on a test vehicle, a test dataset associated with the test vehicle, and a historic maintenance plan associated with the test vehicle. After the prediction model is trained and validated, the application server 104 may operate in the implementation phase.

During the implementation phase, the application server 104 may be further configured to receive a target dataset associated with a target vehicle from one of the database server 106, a driver device associated with the target vehicle, and the transportation service provider associated with the target vehicle. In an embodiment, the target vehicle may be one of the plurality of vehicles 102a-102d. In another embodiment, the target vehicle may be different from the plurality of vehicles 102a-102d. The target dataset may include second maintenance data, second vehicle data, and second booking data for the target vehicle. The second maintenance data, the second vehicle data, and the second booking data are collected and recorded in a similar manner as the first maintenance data, the first vehicle data, and the first booking data are collected and recorded.

The application server 104 may be configured to provide the target dataset as an input to the trained prediction model to determine a maintenance criterion for the target vehicle. The maintenance criterion refers to an optimal condition, with respect to health and performance of the target vehicle, for performing the scheduled maintenance of the target vehicle. In other words, the maintenance criterion may refer to an optimal condition which when satisfied warrants a need for the target vehicle to undergo a scheduled maintenance session. In one embodiment, the maintenance criterion may be an optimal odometer reading range (i.e., a range of total distance travelled) of the target vehicle during which maintenance of the target vehicle should be performed for longevity and optimal performance of the target vehicle.

The application server 104 may be further configured to generate, a scheduled maintenance ticket for the target vehicle based on a real-time odometer reading of the target vehicle and the determined maintenance criterion. The scheduled maintenance ticket may be indicative of a date of a scheduled maintenance of the target vehicle, a time of the scheduled maintenance, a workshop name for the scheduled maintenance, and a workshop address for the scheduled maintenance. The application server 104 may be further configured to communicate the scheduled maintenance ticket to a driver device associated with the target vehicle to notify a driver of the target vehicle regarding the scheduled maintenance.

FIG. 1B is a block diagram that illustrates another system environment 100B for dynamic maintenance scheduling for a vehicle, in accordance with an exemplary embodiment of the disclosure. The system environment 100B includes the plurality of vehicles 102a-102d, the application server 104, the database server 106, the maintenance center 108 having the maintenance system 110, the communication network 112, and a maintenance database 114.

The maintenance database 114 may include suitable logic, circuitry, interfaces, and/or code, executable by the circuitry, that may be configured to store the maintenance data (e.g., the first maintenance data) associated with the plurality of vehicles 102a-102d. The maintenance database 114 may receive the first maintenance data from the maintenance system 110. The maintenance database 114 may receive the first maintenance data periodically or in real-time or near real-time. The maintenance database 114 may be configured to communicate with the maintenance system 110 via the communication network 112.

In another embodiment, instead of the database server 106 (as shown in FIG. 1A), the application server 104 may be configured to collect the first maintenance data, the first booking data, the first vehicle data, and the plurality of maintenance plans, from each vehicle 102a-102d, the maintenance system 110, the maintenance database 114, and the transportation service provider(s) associated with the plurality of vehicles 102a-102d.

FIG. 2A is a schematic diagram that illustrates an exemplary scenario 200A for training the prediction model for dynamic maintenance scheduling for vehicles, in accordance with an exemplary embodiment of the disclosure. For the sake of brevity, the prediction model is shown to be trained based on data associated with the vehicles 102a and 102b. The application server 104 may include a memory 202, a network interface 204, processing circuitry 206, a machine learning engine 208, and the prediction model (hereinafter, referred to and designated as “the prediction model 210”).

The memory 202 may include suitable logic, circuitry, and interfaces that may be configured to store one or more instructions which when executed by the processing circuitry 206 cause the processing circuitry 206 to perform various operations for dynamic scheduling of maintenance for vehicles. The memory 202 may be accessible by the processing circuitry 206, the machine learning engine 208, and the prediction model 210. Examples of the memory 202 may include, but are not limited to, a random-access memory (RAM), a read only memory (ROM), a removable storage drive, a hard disk drive (HDD), a flash memory, a solid-state memory, or the like. It will be apparent to a person skilled in the art that the scope of the disclosure is not limited to realizing the memory 202 in the application server 104, as described herein. In another embodiment, the memory 202 may be realized in the form of a database or a cloud storage working in conjunction with the application server 104, without departing from the scope of the disclosure.

The network interface 204 may include suitable logic, circuitry, interfaces, and/or code, executable by the circuitry, that may be configured to enable the application server 104 to communicate with the database server 106, the maintenance database 114 (shown in FG. 1B), and driver devices of each vehicle 102a and 102b. The network interface 204 may be implemented as a hardware, software, firmware, or a combination thereof. Examples of the network interface 204 may include a network interface card, a physical port, a network interface device, an antenna, a radio frequency transceiver, a wireless transceiver, an Ethernet port, a universal serial bus (USB) port, or the like.

The processing circuitry 206 may include suitable logic, circuitry, interfaces, and/or code, executable by the circuitry, that may be configured to execute the instructions stored in the memory 202 to perform various operations for dynamic scheduling of maintenance for the vehicles. The processing circuitry 206 may be configured to perform various operations associated with data collection and data processing. The processing circuitry 206 may be implemented by one or more processors, such as, but not limited to, an application-specific integrated circuit (ASIC) processor, a reduced instruction set computing (RISC) processor, a complex instruction set computing (CISC) processor, and a field-programmable gate array (FPGA) processor. The one or more processors may also correspond to central processing units (CPUs), graphics processing units (GPUs), network processing units (NPUs), digital signal processors (DSPs), or the like. It will be apparent to a person of ordinary skill in the art that the processing circuitry 206 may be compatible with multiple operating systems.

When the application server 104 is operating in the training phase, the processing circuitry 206 may be configured to receive the first maintenance data, the first booking data, the first vehicle data, and the maintenance plans associated with the vehicles 102a and 102b. In one embodiment, the application server 104 may receive the first maintenance data, the first booking data, the first vehicle data, and the plurality of maintenance plans from the database server 106. In another embodiment (as shown in FIG. 2A), the application server 104 may receive the first maintenance data from the maintenance database 114. The application server 104 may further receive the booking data, the vehicle data, and the maintenance plan from the driver devices associated with the vehicles 102a and 102b. In one example, the driver device of each vehicle 102a and 102b may correspond to a telematics device (not shown) or an OBD device (not shown). The booking data of the vehicles 102a and 102b is collectively referred to as the first booking data. The vehicle data of the vehicles 102a and 102b is collectively referred to as the first vehicle data. The maintenance plan of the vehicles 102a and 102b are collectively referred to as the plurality of maintenance plans. The processing circuitry 206 may be further configured to store the received first maintenance data, the first booking data, the first vehicle data, the maintenance plans in the memory 202 or a cloud database server (not shown).

The processing circuitry 206 may be further configured to cause the machine learning engine 208 to determine the plurality of features (hereinafter, referred to and designated as the plurality of features 212″) by analyzing and processing the collected first maintenance data, the first booking data, the first vehicle data, and the maintenance plans.

The machine learning engine 208 may include suitable logic, circuitry, interfaces, and/or code, executable by the circuitry, that may be configured to perform one or more operations for dynamic maintenance scheduling for the vehicles. Examples of the machine learning engine 208 may include, but are not limited to, an ASIC processor, a RISC processor, a CISC processor, and an FPGA processor. The machine learning engine 208 may also correspond to a CPU, a GPU, an NPU, a DSP, or the like. It will be apparent to a person of ordinary skill in the art that the machine learning engine 208 may be compatible with multiple operating systems. Further, the machine learning engine 208 may include a machine-learning model that implements any suitable machine-learning techniques, statistical techniques, or probabilistic techniques for performing the one or more operations associated with the training of the prediction model 210.

When the application server 104 is operating in the training phase, the machine learning engine 208 may be configured to process and analyze the first maintenance data, the first booking data, the first vehicle data, and the maintenance plans stored in the memory 202. The machine learning engine 208 may use various feature or variable selection techniques to analyze the first maintenance data, the first booking data, the first vehicle data, and the maintenance plans. The machine learning engine 208 may determine the plurality of features 212 that are direct or indirect indicators of a vehicle's health and performance as well as the vehicle's requirement for repair and maintenance based on the first maintenance data, the first booking data, the first vehicle data, and the maintenance plans. For example, the machine learning engine 208 may determine that a mean time between consecutive failures of a vehicle, a count of non-scheduled maintenance sessions of a vehicle, and a count of repairs of a vehicle are indicators of whether repair and maintenance of the vehicle is required. In another example, the machine learning engine 208 may determine that a count of accidents of a vehicle has direct causal relationship with health and performance of a vehicle. Thus, based on the count of accidents of the vehicle, an optimal time interval for repair and maintenance of the vehicle may be predicted or determined. Based on the first maintenance data, the first booking data, the first vehicle data, and the maintenance plans, the machine learning engine 208 may be further configured to determine the plurality of feature values corresponding to the plurality of features 212. Hereinafter, the plurality of feature values are referred to and designated as “the plurality of features values 214”. The plurality of feature values 214 may include numerical values, alphabetical values, grades, or the like associated with the corresponding plurality of features 212. For example, a feature may be a total distance travelled by a vehicle per day. Therefore, the feature value may be 200 kilometers as indicated by per day increment in an odometer reading of the vehicle. The plurality of feature values 214 may provide a historical pattern of the health, performance, and corresponding scheduled or non-scheduled maintenance of each vehicle 102a and 102b.

In an embodiment, the plurality of features 212 determined by the machine learning engine 208 may include a mean time between consecutive failures of a vehicle. The mean time between consecutive failures of a vehicle may refer to an average time between two subsequent failures of the vehicle. In such an embodiment, the plurality of feature values 214 include the mean time between consecutive failures of each vehicle 102a and 102b. A low value of the mean time between consecutive failures of a vehicle indicates that the vehicle is prone to frequent failures and needs frequent repair and maintenance to fix the causes of failures. A high value of the mean time between consecutive failures of a vehicle indicates that the vehicle does not suffer from frequent failures, and therefore, does not need frequent repair and maintenance.

In an embodiment, the plurality of features 212 determined by the machine learning engine 208 may include a count of non-scheduled maintenance sessions of a vehicle, a count of repairs of a vehicle, a count of major accidents of a vehicle, and a unit distance travelled by a vehicle between consecutive maintenance sessions in the past. In such an embodiment, the plurality of feature values 214 may include the count of non-scheduled maintenance sessions of each vehicle 102a and 102b, the count of repairs of each vehicle 102a and 102b, the count of major accidents of each vehicle 102a and 102b, the unit distance travelled by each vehicle 102a and 102b between consecutive maintenance sessions in the past, and the unit distance travelled by each vehicle 102a and 102b after a corresponding non-scheduled maintenance session.

The count of non-scheduled maintenance sessions of a vehicle refers to a number of unplanned maintenance sessions required to keep the vehicle functioning. The count of non-scheduled maintenance sessions is further indicative of a number of times the vehicle has been damaged to an extent that it had to be repaired and maintained immediately. The count of non-scheduled maintenance sessions of the vehicle may be further indicative of an additional cost that is being borne by the transportation service provider due to poor health and additional downtime of the vehicle. In one example, the vehicle 102a may be two years old and may have undergone 6 scheduled maintenance sessions in the two years of use. However as per the maintenance data or records of the vehicle 102a, the vehicle 102a has undergone 10 maintenance sessions. Thus, the count of non-scheduled maintenance sessions for the vehicle 102a is four (i.e., 10−6=4).

A count of repairs of a vehicle refers to a number of times one or more components of the vehicle have been repaired in order to keep the vehicle in good health. In an embodiment, the count of repairs is indicative of a number of times the vehicle has been damaged to an extent that a repair of the component(s) of the vehicle has been performed to keep the vehicle in working state. A high count of repairs of a vehicle is indicative of one of careless attitude of a driver of the vehicle, frequent damages being caused to the vehicle, and a bad health of the vehicle. A low count of repairs of a vehicle is indicative of one of a good health of the vehicle, a well-maintained state of the vehicle, and a careful and attentive attitude of the driver towards the vehicle.

A count of major accidents of a vehicle refers to a number of times the vehicle has been through critical accidents. The major accidents may further refer to one or more accidents that has caused physical damages and performance deterioration of the vehicle. In an embodiment, a low count of the major accidents of the vehicle is indicative of less damages and fewer performance issues caused to the vehicle due to the major accidents of the vehicle. A high count of the major accidents of the vehicle is indicative of frequent damages and performance issues caused to the vehicle due to accidents. For example, the vehicle 102a may have been in accident ten times. Further, four out of ten accidents may have been minor with no damage being caused to the vehicle; however, during the remaining six accidents various physical damages may have been caused to the vehicle 102a, thus warranting a high repair time. Hence, a count of major accidents of the vehicle 102a is six. Distinction criteria to distinguish a minor accident from a major accident may be specified by the transportation service provider associated with the vehicles 102a and 102b. In one embodiment, the distinction criteria may be a cost associated with accidental damage repair. For example, if the cost associated with accidental damage repairs exceeds a first threshold cost, the accident of the vehicle 102a may be considered as a major accident, and if the cost does not exceed to first threshold, the accident might be considered as a minor accident. In another embodiment, the distinction criteria may be one or more components associated with accidental damage. For example, if the damage is only caused to the headlights during the accident of the vehicle 102a, the accident of the vehicle 102a may be considered as a minor accident. However, if during the accident the windshield glass of the vehicle 102a is shattered, the accident might be considered as a major accident.

A unit distance travelled by a vehicle between consecutive maintenance sessions in the past refers to a distance travelled by the vehicle between two subsequent maintenance sessions. The unit distance may refer to a distance travelled between two consecutive scheduled maintenance sessions, two consecutive non-scheduled maintenance session, or a scheduled and a non-scheduled maintenance session. A low measure of distance travelled between two maintenance sessions indicate that the vehicle is of suboptimal health and facing frequent health issues. In one example, the vehicle 102a may have had a non-scheduled maintenance session at an odometer reading of 10,000 km and another non-scheduled maintenance session at the odometer reading of 12,000 km. Thus, the vehicle 102a has only travelled 2,000 km (i.e., less than expected distance travelled between maintenance sessions) between the two non-scheduled maintenance sessions, which is an indicator of deteriorating health of the vehicle 102a. The unit distance travelled between a scheduled maintenance session and a non-scheduled maintenance session is indicative of an unnecessary downtime the vehicle had to undergo due to two separate maintenance sessions. For example, the vehicle 102a may have had a non-scheduled maintenance session at an odometer reading of 14,000 km and a scheduled maintenance session at the odometer reading of 15,000 km. Thus, the vehicle 102a travelled only 1,000 km between the non-scheduled maintenance session and the subsequent scheduled maintenance session. Due to two separate non-scheduled and scheduled maintenance sessions, the vehicle 102a had to undergo downtime twice. The scheduled maintenance session may have been combined with the non-scheduled maintenance to reduce the downtime of the vehicle 102a.

In an embodiment, the plurality of features 212 determined by the machine learning engine 208 may further include a count of non-scheduled repairs of a vehicle, a maintenance cost of a vehicle, a cost incurred due to accidents of a vehicle, a repair downtime of a vehicle, an average cost incurred for historical maintenance sessions of a vehicle, a frequency of maintenance sessions of a vehicle, and a deviation in a frequency of maintenance sessions of a vehicle. In such an embodiment, the plurality of feature values 214 include the count of non-scheduled repairs of each vehicle 102a and 102b, the maintenance cost of each vehicle 102a and 102b, the cost incurred due to accidents of each vehicle 102a and 102b, the repair downtime of each vehicle 102a and 102b, the average cost incurred for historical maintenance sessions of each vehicle 102a and 102b, the frequency of maintenance sessions of each vehicle 102a and 102b, and the deviation in a frequency of maintenance sessions of each vehicle 102a and 102b.

A count of non-scheduled repairs of a vehicle refers to a number of times various components of the vehicle have been repaired, at each non-scheduled maintenance session, without any prior information to keep the vehicle functioning. In an embodiment, the count of non-scheduled repairs is indicative of a number of times one or more components of the vehicle has been damaged to an extent that it had to be repaired immediately.

A maintenance cost of a vehicle may refer to a cost borne by the transportation service provider or the vehicle owner on vehicle maintenance to keep the vehicle in good health. A high maintenance cost of the vehicle may reduce the profitability or cause loss to the transportation service provider or the vehicle owner.

A cost incurred due to accidents of a vehicle may refer to an amount paid or incurred by the transportation service provider or the vehicle owner to repair accidental damages caused to the vehicle. Frequent accidents or major accidents of the vehicle may cause the transportation service provider to bear a high cost. For example, the vehicle 102a may have been subjected to ten accidents in the past two years and the vehicle 102b may have been subjected to twenty accidents in the past two years. Therefore, a cost incurred due to the accidents of the vehicle 102b may be higher than a cost incurred due to the accidents of the vehicle 102a.

A repair downtime of a vehicle refers to a time-interval for which the vehicle has been out of service due to repair and maintenance actions. The repair downtime may be indicative of one of occurrence of one or more major or minor performance issues associated with the vehicle and a time spent on repair and maintenance of the vehicle for correcting those performance issues. For example, the vehicle 102a may have been put to use on Mar. 30, 2012. Further, on Mar. 30, 2013, the vehicle 102a is brought to the maintenance center 108 for maintenance and repair. The vehicle 102a is again put to use on Apr. 30, 2013. Thus, the repair downtime of the vehicle 102a is one month.

An average cost incurred for historical maintenance sessions of a vehicle refers to a mean cost incurred during historical scheduled and non-scheduled maintenance sessions of the vehicle. The average cost incurred for historical maintenance sessions may be determined by obtaining a ratio between a total cost incurred for maintenance of the vehicle and a total count of maintenance sessions of the vehicle. In one example, a total cost of maintenance of the vehicle 102a may be $2,500 and a total count of maintenance sessions of the vehicle 102a may be five. Therefore, the average cost incurred for historical maintenance sessions of the vehicle 102a may be $500 (i.e., 2,500/5).

A frequency of maintenance sessions of a vehicle refers to a count of maintenance sessions that the vehicle requires in a unit time-interval. A high frequency of maintenance sessions of the vehicle may be indicative of a loss caused to the transportation service provider due to frequent maintenance sessions and downtime of the vehicle. In an example, the vehicle 102a may have two maintenance sessions per month. Therefore, the frequency of maintenance sessions of the vehicle 102a may be two maintenance sessions per month. In another example, the vehicle 102a may have 36 maintenance sessions in a year. Therefore, the vehicle 102a may have the frequency of maintenance sessions equal to 3 maintenance sessions per month (i.e., 36/12).

A deviation in a frequency of maintenance sessions of a vehicle is indicative of a number of times a vehicle has either delayed or advanced scheduled maintenances from manufacturer's mandate. The deviation may indicate that the vehicle has missed one or more scheduled maintenance sessions in the past. A cumulative delay due to multiple deviations may cause a deterioration in health of the vehicle and may lead to frequent requirement of maintenance at an older age. For example, the vehicle 102a is expected to have a scheduled maintenance at an odometer reading of 10,000 km. However, the vehicle 102a may be taken to the maintenance center 108 for the scheduled maintenance at the odometer reading of 15,000 km. Therefore, the schedule maintenance is delayed by 5,000 km. Further, the vehicle 102a may have another scheduled maintenance at an odometer reading of 20,000 km. However, the vehicle 102a may be taken to the maintenance center 108 for the scheduled maintenance at the odometer reading of 25,000 km. Therefore, the vehicle 102a may have experienced another delay of 5,000 km. Here, the deviation in frequency of maintenance sessions is two.

The deviation in the frequency of maintenance sessions of a vehicle is further indicative of a change in a count of times the vehicle undergoes scheduled maintenance in a fixed time-period. For example, in the year 2018, the vehicle 102a may have undergone three scheduled maintenance sessions and in the year 2019 the vehicle 102a may have undergone only one scheduled maintenance session. Such a deviation may indicate that either the driver of the vehicle 102a has missed one or more scheduled maintenance sessions in 2019 or the vehicle 102a has not been driven to the same extent in 2019 as compared to 2018. In another example, in the year 2018, the vehicle 102a may have undergone three scheduled maintenance sessions and in the year 2019 the vehicle 102a may have undergone only eight scheduled maintenance sessions. Such a deviation may indicate that either the vehicle 102a has been driven more in 2019 as compared to 2018 or the health of the vehicle 102a has deteriorated, thus, warranting extra scheduled maintenance sessions.

In one embodiment, the plurality of features 212 may further include a cost per unit distance forecasted for one or more components of a vehicle and an asset health index of a vehicle. In such an embodiment, the plurality of feature values 214 include the cost per unit distance values forecasted for the one or more components of each vehicle 102a and 102b and the asset health index of each vehicle 102a and 102b.

A cost per unit distance forecasted for one or more components of a vehicle may refer to a cost that is projected to be incurred due to the one or more components of the vehicle during a future time-interval. Examples of the future time-interval may include one day, one week, two weeks, one months, or the like. The forecasted cost per unit distance for the one or more components may further indicate a projected cost that the transportation service provider may be required to bear for keeping the vehicle operational during the future time-interval. For example, a high cost per unit distance value incurred on one or more components of the vehicle may indicate that the vehicle is prone to cause monetary loss to the transportation service provider. In one example, the forecasted cost per unit distance may correspond to forecasted cost per kilometer for the one or more components of the vehicle. Leveraging the forecasted cost per unit distance for dynamic scheduling of maintenance allows efficient and timely detection of abnormal conditions within the vehicle, resulting in minimum unforeseen downtime for the vehicle.

An asset health index of a vehicle is a collective indicator of a performance, a health, a utilization, and a profitability of the vehicle. The asset health index may be a grade, a percentage, a score, or the like provided to the vehicle based on the performance, the health, the utilization, and the profitability of the vehicle. The asset health index may be determined by the application server 104 based on information received from the vehicle. A deterioration in the asset health index may be indicative of a frequent requirement of maintenance by the vehicle.

In one embodiment, the plurality of features 212 may further include a count of dormant days of a vehicle, a count of active days of a vehicle, and a deviation in a count of active days between consecutive scheduled maintenance sessions of a vehicle. In such an embodiment, the plurality of feature values 214 may include the count of dormant days of each vehicle 102a and 102b, the count of active days of each vehicle 102a and 102b, the deviation in the count of active days between consecutive scheduled maintenance sessions of each vehicle 102a and 102b.

A count of dormant days of a vehicle refers to a time-interval for which the vehicle has been out of use in the entire life span of the vehicle. For example, the vehicle 102a may have been manufactured on Jul. 20, 2010 and put to use on Jul. 20, 2013. Thus, on Jul. 20, 2014, the count of dormant days of the vehicle 102a is 1096 days (i.e., three years), whereas the actual age of the vehicle 102a is four years. Further, the count of dormant days of the vehicle is an indicative of a time-interval during which the one or more components of the vehicle have been resting. The count of dormant days of the vehicle may indicate a probable damage caused to the vehicle and the components due to prolonged period of rest. In one example, a high count of dormant days may cause rusting of the one or more components of the vehicle.

A count of active days of a vehicle refers to a time-interval for which the vehicle has been put to use in the entire life span of the vehicle. For example, the vehicle 102a may have been manufactured on Jul. 20, 2010 and put to use on Jul. 20, 2012. Thus, on Jul. 20, 2014, the active age of the vehicle 102a is 730 days (i.e., two years), whereas the actual age of the vehicle 102a is four years. Further, the count of active days of the vehicle indicates a time-interval during which the one or more components of the vehicle have been active. The count of active days of the vehicle may have a high impact on the health of the vehicle as the one or more components may have been utilized to its full capacity during the active days.

A deviation in a count of active days during a defined time-interval refers to an increase or decrease in the count of active days of a vehicle within the defined time-interval. The defined time-interval may be 1 month, 2, months, 3, months, 4 months, 5 months, or the like. In one example, the defined time-interval may be 6 months. For example, during the first six months of use, the vehicle 102a may have been driven for 120 days. Further, during the subsequent six months of use, the vehicle 102a may have been driven for 120 days. However, during the past 6 months, the vehicle 102a may have been only driven for 50 days. Therefore, the vehicle 102a may have a deviation of 70 active days during the past 6 months.

In an embodiment, the deviation in a count of active days between consecutive scheduled maintenance sessions of a vehicle refers to a change in the count of active days of a vehicle between two subsequent scheduled maintenance sessions. For example, the vehicle 102a may have had a first scheduled maintenance session on Jan. 10, 2020 and a second scheduled maintenance session on Jul. 10, 2020. The vehicle 102a may only be driven on weekdays (i.e., Monday-Friday) and put to rest on Saturday and Sunday. Thus, the number of active days between the first and second scheduled maintenance sessions for the vehicle 102a is 131 days. Further, the vehicle 102a may have had a third scheduled maintenance session on Oct. 20, 2020. Thus, the number of active days between the second and third scheduled maintenance sessions for the vehicle 102a is 73 days and the deviation in the count of active days between two consecutive scheduled maintenance sessions for the vehicle 102a is 58 active days.

In one embodiment, the plurality of features 212 may further include a dry run distance travelled by a vehicle, a trip run distance travelled by a vehicle, an excess run distance travelled by a vehicle, a total distance travelled per day by a vehicle, and an average total distance travelled per day by a vehicle. In such an embodiment, the plurality of feature values 214 include the dry run distance travelled by each vehicle 102a and 102b, the trip run distance travelled by each vehicle 102a and 102b, the excess run distance travelled by each vehicle 102a and 102b, the total distance travelled per day by each vehicle 102a and 102b, and the average total distance travelled per day by each vehicle 102a and 102b.

A dry run distance travelled by a vehicle refers to a distance travelled by the vehicle without having a booking. A trip distance travelled by the vehicle refers to a distance travelled by the vehicle for completing a booking. An excess distance travelled by the vehicle refers to a distance travelled by the vehicle without any information to the transportation service provider. A total distance travelled per day by the vehicle refers to a sum of the dry run distance, the trip distance, and the excess distance travelled by the vehicle. For example, a total distance travelled by the vehicle 102a in a day may be “120 kilometers”. The vehicle 102a may have been driven for “80 kilometers” (i.e., trip distance) to fulfill a plurality of bookings. The vehicle 102a may have been driven for “20 kilometers” (i.e., dry run distance) without any booking. Further, the vehicle 102a may have been driven for “20 kilometers” (i.e., excess distance) by the corresponding driver for some personal work.

An average distance travelled by a vehicle per day may refer to a mean distance travelled by the vehicle per day. The average distance travelled by the vehicle per day may be determined by obtaining a ratio of a total distance travelled by the vehicle to an age of the vehicle in days. For example, the vehicle 102a may have an age of 60 days and the vehicle 102a may have travelled 10,000 kms. Therefore, the average distance travelled by the vehicle 102a per day may be 167 kms per day.

In an embodiment, the plurality of features 212 may further include a vehicle make, a vehicle model, a region of operation of a vehicle, an age of a vehicle, a fuel type of a vehicle, a count of unique drivers of a vehicle, and an odometer reading of a vehicle. In such an embodiment, the plurality of feature values 214 include the make of each vehicle 102a and 102b, the model of each vehicle 102a and 102b, the region of operation of each vehicle 102a and 102b, the age of each vehicle 102a and 102b, the fuel type of each vehicle 102a and 102b, and the odometer reading of each vehicle 102a and 102b. By taking into account, the vehicle make, the vehicle model, the region of operation, the vehicle age, and the fuel type of the vehicle, the machine learning engine 208 ensures that training of the prediction model 210 is normalized based on vehicle configuration and parameters that have a direct or indirect causal relationship with a requirement of maintenance by different vehicles.

The count of unique drivers associated with a vehicle refers to a number of drivers that have been associated with the vehicle in the entire life-span of the vehicle. For example, the vehicle 102a may be five years old and may have been driven by three drivers. Therefore, the count of unique drivers for the vehicle 102a may be three. Further, the count of drivers may affect the health and performance of the vehicle as each driver may have driven and maintained the vehicle differently. In other words, different drivers may exhibit different driving styles and behaviors that may positively or negatively impact the health and performance of the vehicle affecting a need of maintenance of the vehicle.

The odometer reading of a vehicle indicates a unit distance that has been travelled by the vehicle during its entire life-span. For example, an odometer reading of the vehicle 102a may be 10,000 kilometers. Therefore, the total distance travelled by the vehicle 102a may be 10,000 kilometers. The total distance travelled by the vehicle may be indicative of wear and tear caused to the vehicle.

In one embodiment, each feature of the plurality of features 212 may be assigned a weight based on a degree of correlation between the feature and a requirement of maintenance of a vehicle. For example, a first feature (e.g., the count of repairs) may be assigned a higher weight than a second feature (e.g., the excess distance travelled by the vehicle), based on determination by the machine learning engine 208 that the count of repairs is a better indicator of maintenance requirement by the vehicle than the excess distance travelled by the vehicle.

In one embodiment, the machine learning engine 208 may be configured to train the prediction model 210 based on the plurality of features 212 and the plurality of feature values 214. The machine learning engine 208 may input the plurality of features 212, the plurality of feature values 214, and the maintenance plans of the vehicles 102a and 102b to the prediction model 210 for training. Based on the plurality of features 212 and the plurality of feature values 214, the prediction model 210 may learn a pattern or trend in the plurality of feature values 214 corresponding to the historical scheduled maintenance sessions of the vehicles 102a and 102b that were too early, too late, or on time. In other words, during training, the prediction model 210 learns (or determines) feature values of the plurality of features 212 for early, late, or on time scheduled maintenance, based on the plurality of feature values 214 and the historical scheduled maintenance sessions of the vehicles 102a and 102b. Based on the plurality of features 212 and the plurality of feature values 214, the prediction model 210 may further learn an optimal distance between a scheduled maintenance session and a non-scheduled maintenance session. The prediction model 210 may learn to minimize a downtime of the vehicle by combining closely occurring scheduled and non-scheduled maintenance sessions. For example, the vehicle 102a may have had a scheduled maintenance session at the odometer reading of 15,000 km and a battery of the vehicle 102a may have been repaired at an odometer reading of 15,450 km during a non-scheduled maintenance session. Hence, based on the plurality of features 212 and the plurality of feature values 214, the prediction model 210 may learn to combine such closely occurring scheduled and non-scheduled maintenance sessions. The machine learning engine 208 may train the prediction model 210 in a way that when provided with new maintenance data, new vehicle data, and new booking data associated with a vehicle, the prediction model 210 may correctly predict a maintenance criterion as per the maintenance requirement of the vehicle. The maintenance criterion may refer to an attribute, a rule, a condition, or the like based on which a maintenance has to be scheduled for the vehicle. The machine learning engine 208 may train the prediction model 210 using one or more classification algorithms such as logistic regression classification algorithm, or the like. Examples of the prediction model 210 may include but are not limited to, a Support Vector Machine (SVM), a Logistic Regression model, a Bayesian Classifier, a Decision Tree Classifier, a Copula-based prediction model, a K-Nearest Neighbors (KNN) Classifier, or a Random Forest (RF) Classifier, a deep learning based model, or a neural network based model.

In another embodiment, along with the first maintenance data, the first booking data, the first vehicle data, and the maintenance plans, the processing circuitry 206 may further receive diagnostic trouble codes (DTCs) and sensor data from each vehicle 102a and 102b. Sensor data may be generated by one or more sensors installed or placed in each of the vehicle 102a and 102b. In such a scenario, the machine learning engine 208 may be further configured to train the prediction model 210 based on the received DTCs and the sensor data. Further, training the prediction model 210 based on the DTCs and the sensor data may enable the prediction model 210 to correlate a requirement of scheduled maintenance with the DTCs and the sensor data. Such correlation may enable the prediction model 210 to identify early warnings and possible issues associated with a vehicle, resulting in a need of scheduled maintenance.

In one embodiment, the maintenance criterion may be an odometer reading range of the vehicle during which the vehicle may require maintenance. In another embodiment, the maintenance criterion may be a fuel consumption range of the vehicle. In another embodiment, the maintenance criterion may be a range of a count of recharge cycles of one or more batteries of the vehicle. In another embodiment, the maintenance criterion may be a frequency range of an error code prompted by the OBD device of the vehicle.

In the current embodiment, for the sake of brevity, training data (i.e., the plurality of features 212 and the plurality of feature values 214) has been shown to correspond to a sample size of two (i.e., two vehicles 102a and 102b). However, in an actual implementation, the training data may correspond to a large sample size (e.g., a sample size of a thousand vehicles, ten thousand vehicles, or a million vehicles).

The machine learning engine 208 may validate an accuracy level of the trained prediction model 210. For example, the machine learning engine 208 may provide a test dataset associated with a test vehicle as an input to the trained prediction model 210. The test dataset may include past maintenance data, past vehicle data, and past booking data associated with the test vehicle. The test vehicle may be identified to have a history of multiple scheduled and non-scheduled maintenance sessions. As an output, the trained prediction model 210 may output a maintenance criterion for the test vehicle. The maintenance criterion may be indicative of an odometer reading range of the test vehicle during which the test vehicle should be undergo maintenance. The machine learning engine 208 may be configured to compare the maintenance criterion determined by the trained prediction model 210 with a known maintenance session performed in the past for the test vehicle and generate a validation output, i.e., the machine learning engine 208 may check whether the trained prediction model 210 has determined the maintenance criterion that is indicative of an odometer reading range of the test vehicle during which the test vehicle has had the maintenance session in the past. The validation output may be used as a feedback to improve the accuracy level of the trained prediction model 210. In one embodiment, the validation of the prediction model 210 may be an iterative process until a desired accuracy level is achieved for the prediction model 210.

FIG. 2B is a schematic diagram that illustrates an exemplary scenario 200B for determining a maintenance criterion of a target vehicle 216, in accordance with an exemplary embodiment of the disclosure. The application server 104 may include the memory 202, the network interface 204, the processing circuitry 206, the machine learning engine 208, and the trained prediction model 210. For the sake of brevity, the target vehicle 216 is assumed to be a different vehicle that was not a part of the training phase. However, the application server 104 may utilize the trained prediction model 210 to determine the maintenance criterion for any vehicle irrespective of make, model, age, or the like of the vehicle.

In the implementation phase, the application server 104 may be configured to receive a target dataset associated with the target vehicle 216. The target dataset includes second maintenance data, second vehicle data, and second booking data associated with the target vehicle 216. The application server 104 may be configured to receive the target dataset from a driver device 218 associated with the target vehicle 216, the maintenance database 114, and/or the database server 106. For example, the application server 104 may receive the second booking data and the second vehicle data from the driver device 218 associated with the target vehicle 216.

The second maintenance data of the target vehicle 216 may be indicative of information pertaining to a mean time between consecutive failures of the target vehicle 216, a count of non-scheduled maintenance sessions of the target vehicle 216, a count of repairs of the target vehicle 216, a count of major accidents of the target vehicle 216, and a unit distance travelled by the target vehicle 216 between consecutive maintenance sessions in past. The second maintenance data of the target vehicle 216 may be further indicative of information pertaining to a unit distance travelled by the target vehicle 216 after a non-scheduled maintenance session, a count of non-scheduled repairs of the target vehicle 216, a maintenance cost of the target vehicle 216, and a cost incurred due to accidents of the target vehicle 216. The second maintenance data of the target vehicle 216 may be further indicative of information pertaining to a repair downtime of the target vehicle 216, an average cost incurred for historical maintenance sessions of the target vehicle 216, a frequency of maintenance sessions of the target vehicle 216, and a deviation in a frequency of maintenance sessions of the target vehicle 216.

The second booking data of the target vehicle 216 may be indicative of information pertaining to a dry run distance travelled by the target vehicle 216, a trip distance travelled by the target vehicle 216, an excess distance travelled by the target vehicle 216, a total distance travelled per day by the target vehicle 216, and an average total distance travelled per day by the target vehicle 216.

The second vehicle of the target vehicle 216 may be indicative of information pertaining to a make of the target vehicle 216, a model of the target vehicle 216, a region of operation of the target vehicle 216, an age of the target vehicle 216, and a count of unique drivers of the target vehicle 216. The second vehicle of the target vehicle 216 may be further indicative of information pertaining to an odometer reading of the target vehicle 216, a count of dormant days of the target vehicle 216, a count of active days of the target vehicle 216, a deviation in a count of active days between consecutive scheduled maintenance sessions of the target vehicle 216, a cost per unit distance forecasted for one or more components of the target vehicle 216, and an asset health index of the target vehicle 216.

In one embodiment, the target dataset may be provided as input to the trained prediction model 210. In another embodiment, a new plurality of feature values for the plurality of features 212 may be determined based on the target dataset such that the new plurality of feature values are provided as input to the trained prediction model 210. In one embodiment, the processing circuitry 206 may be configured to determine the new plurality of feature values based on the target dataset. In another embodiment, the machine learning engine 208 may be configured to determine the new plurality of feature values based on the target dataset.

As an output to the inputted new plurality of feature values, the trained prediction model 210 may be configured to determine the maintenance criterion for the target vehicle 216. In other words, based on the inputted new plurality of feature values, the prediction model 210 may understand the past and real-time condition of the target vehicle 210, a utilization pattern of the target vehicle 216, a health trend exhibited by the target vehicle 210, and the geographical and environmental conditions to which the target vehicle 210 is exposed. Thus, the prediction model 210 predicts the maintenance criterion that indicates when the target vehicle 210 may need scheduled maintenance as per the past and real-time condition of the target vehicle 210, the utilization pattern of the target vehicle 216, the health trend exhibited by the target vehicle 210, and the geographical and environmental conditions to which the target vehicle 210 is exposed. In one embodiment, the maintenance criterion determined by the trained prediction model 210 is an odometer reading range of the target vehicle 216. The target vehicle 216 may be taken for a maintenance session during the odometer reading range. Beneficially, providing the odometer reading range makes it convenient for a driver of the target vehicle 216 to plan the maintenance of the target vehicle 216.

The processing circuitry 206 may be configured to generate a scheduled maintenance ticket for the target vehicle 216 based on a real-time odometer reading of the target vehicle 216 and the maintenance criterion. The processing circuitry 206 may be configured to determine a threshold odometer reading based on the determined maintenance criterion. The threshold odometer reading may lie between the upper limit and the lower limit of the odometer reading range. In one embodiment, the processing circuitry 206 may determine the threshold odometer reading based on a maintenance history of the target vehicle 216. In another embodiment, the processing circuitry 206 may determine the threshold odometer reading based on an input from the driver of the target vehicle 216. In one example, the lower limit of the odometer reading range may be determined as the threshold odometer reading by the processing circuitry 206. The processing circuitry 206 may be configured to generate the scheduled maintenance ticket for the target vehicle 216 when the real-time odometer reading of the target vehicle 216 is greater than or equal to the threshold odometer reading. The scheduled maintenance ticket may correspond to a maintenance appointment for the target vehicle 216 regarding a scheduled maintenance thereof. The scheduled maintenance ticket may include a date of the scheduled maintenance of the target vehicle 216, a time of the scheduled maintenance, a workshop name for the scheduled maintenance, and a workshop address for the scheduled maintenance.

In an embodiment, the processing circuitry 206 may determine the date of the scheduled maintenance of the target vehicle 216, the time of the scheduled maintenance, the workshop name for the scheduled maintenance, and the workshop address for the scheduled maintenance based on availability of the target vehicle 216 and the allotted workshop for the scheduled maintenance. Based on the real-time odometer reading, the target vehicle 216 may require a maintenance session on Nov. 15, 2017 at 3:00 pm. A first workshop may be available on Nov. 15, 2017 from 10:00 am to 2:00 pm and a second workshop may be available on Nov. 15, 2017 from 2:00 pm to 8:00 pm. Therefore, the processing circuitry 206 may determine that the second workshop may be available for the scheduled maintenance session of the target vehicle 216 on Nov. 15, 2017 at 3:00 pm. Thus, the generated scheduled maintenance ticket may include the address of the second workshop.

In an embodiment, the processing circuitry 206 may be configured to determine a timeliness factor of the driver of the target vehicle 216 for adhering to generated scheduled maintenance tickets. For example, the processing circuitry 206 may determine whether the target vehicle 216 is taken to the allotted workshop (e.g., the maintenance center 108) as per the date and time mentioned in the scheduled maintenance ticket. In one scenario, the timeliness factor determined by the processing circuitry 206 may indicate a positive deviation in the timeliness of the driver to take the target vehicle 216 to the allotted workshop, i.e., a delay in taking the target vehicle 216 to the allotted workshop. In another scenario, the timeliness factor determined by the processing circuitry 206 may indicate a negative deviation in the timeliness of the driver to take the target vehicle 216 to the allotted workshop, i.e., the target vehicle 216 may be taken to the allotted workshop earlier than the date and time mentioned in the scheduled maintenance ticket. In another scenario, the timeliness factor determined by the processing circuitry 206 may indicate no deviation in the timeliness of the driver to take the target vehicle 216 to the allotted workshop, i.e., the target vehicle 216 may be taken to the allotted workshop as per the date and time mentioned in the scheduled maintenance ticket. Based on the determined timeliness factor, the processing circuitry 206 may select one of a plurality of outcomes for the driver of the target vehicle 216. In one example, the driver of the target vehicle 216 may be penalized based on non-adherence of the scheduled maintenance ticket. In another embodiment, the driver of the target vehicle 216 may be incentivized based on adherence to the scheduled maintenance ticket. In another embodiment, the driver of the target vehicle 216 may be assigned to another vehicle.

In an embodiment, the processing circuitry 206 may be configured to monitor a time gap between consecutive scheduled maintenance tickets generated for the target vehicle 216. In an embodiment, when the time gap between consecutive scheduled maintenance tickets is less than a baseline time period, the processing circuitry 206 may deduce that the health of the target vehicle 216 may be deteriorating. In one embodiment, if a driver score of the driver of the target vehicle 216 is also declining, the processing circuitry 206 may draw an inference that the deterioration in the health of the target vehicle 216 is due to a declining performance of the driver. In such a scenario, the processing circuitry 206 may select to penalize the driver for the bad performance. In one embodiment, if the driver score of the driver of the target vehicle 216 is high and the asset health index of the target vehicle 216 is declining, the processing circuitry 206 may draw an inference that the deterioration in the health of the target vehicle 216 is due to a performance issue of the target vehicle 216. Thus, based on the monitoring of the time gap between consecutive scheduled maintenance tickets of the target vehicle 216, the processing circuitry 206 draws different inferences that enable the processing circuitry 206 to select one of the plurality of outcomes for the driver of the target vehicle 216 and perform predictive asset management.

In another embodiment, the maintenance criterion may be the fuel consumption range of the target vehicle 216. In such an embodiment, the processing circuitry 206 may be configured to generate the scheduled maintenance ticket based on the current or real-time fuel consumption reading of the target vehicle 216. The processing circuitry 206 may generate the scheduled maintenance ticket when the real-time fuel consumption by the target vehicle 216 may be greater than or equal to a threshold fuel consumption. For example, the maintenance criterion may indicate that the target vehicle 216 may need a maintenance when its fuel consumption ranges between 50,000 liters to 60,000 liters. The threshold fuel consumption may be 55,000 liters. Therefore, the processing circuitry 206 may generate the scheduled maintenance ticket for the target vehicle 216 based on a real-time fuel consumption of the target vehicle 216 being greater than or equal to 55,000 liters.

In another embodiment, when the target vehicle 216 is an electric vehicle, the maintenance criterion may be the range of count of recharge cycles of the one or more batteries of the target vehicle 216. The processing circuitry 206 may be configured to generate the scheduled maintenance ticket based on the real-time count of recharge cycles of the one or more batteries of the target vehicle 216. The processing circuitry 206 may generate the scheduled maintenance ticket when the count of recharge cycles of the one or more batteries of the target vehicle 216 may be greater than or equal to a threshold count of recharge cycles. For example, the maintenance criterion may indicate that the target vehicle 216 may need a maintenance when the count of recharge cycles of the one or more batteries of the target vehicle 216 ranges between 1000 cycles to 1200 cycles. The threshold count of recharge cycles may be 1100 cycles. Therefore, the processing circuitry 206 may generate the scheduled maintenance ticket for the target vehicle 216 based on a real-time count of recharge cycles of the one or more batteries being greater than or equal to 1100 cycles.

In another embodiment, the maintenance criterion may be the frequency of an error code prompted by the OBD device of the target vehicle 216. In such an embodiment, the processing circuitry 206 may be configured to generate the scheduled maintenance ticket based on a count of error codes generated by the OBD device of the target vehicle 216. The processing circuitry 206 may generate the scheduled maintenance ticket when the count of error codes is greater than or equal to a threshold value. For example, the maintenance criterion may indicate the target vehicle 216 may need a maintenance when a count of error codes generated by the OBD device of the target vehicle 216 is greater than or equal to 25. Therefore, the processing circuitry 206 may generate the scheduled maintenance ticket for the target vehicle 216 based on a real-time count of error codes generated by the OBD device being greater than or equal to 25.

The processing circuitry 206 may be further configured to communicate the scheduled maintenance ticket to the driver device 218 of the target vehicle 216. The scheduled maintenance ticket may be utilized by the driver of the target vehicle 216 to take the target vehicle 216 for maintenance. In one embodiment, the processing circuitry 206 may be configured to communicate an odometer reading notification, based on odometer reading range, to the driver device 218. In another embodiment, the processing circuitry 206 may be configured to communicate an appointment notification based on generation of the scheduled maintenance ticket for maintenance of the target vehicle 216.

In an embodiment, the processing circuitry 206 may be configured to receive a feedback from the driver of the target vehicle 216 in the form of a voice feedback, a text feedback, or a signal feedback in response to the determined maintenance criterion of the target vehicle 216. For example, a maintenance criterion or a type of maintenance criterion may be customized by the driver through the feedback for scheduling the maintenance of the target vehicle 216.

In an embodiment, the maintenance criterion, generated by the trained prediction model 210 may be dynamic in nature. The maintenance criterion of the target vehicle 216 may change with respect to physical and environmental conditions to which the target vehicle 216 is exposed. For example, a current odometer reading of the target vehicle 216 may be 20,000 km. The prediction model 210 may have determined that the target vehicle 216 may require maintenance during the odometer reading range 21,000 km to 23,000 km. For next three weeks, the target vehicle 216 may be driven with utmost care and within a geographical region having favorable environmental conditions. Therefore, based on the maintenance data, the vehicle data, and the booking data of the target vehicle 216 for the past three weeks, the prediction model 210 may determine a new maintenance criterion indicative of the odometer reading range “23,000 to 25,000”. A delay in the scheduled maintenance session exhibited by the maintenance criterion may be indicate that the target vehicle 216 has been well taken care of. Alternatively, an early scheduling of the scheduled maintenance session indicated by the maintenance criterion may be because the target vehicle 216 may have been exposed to uncertain and unfavorable conditions.

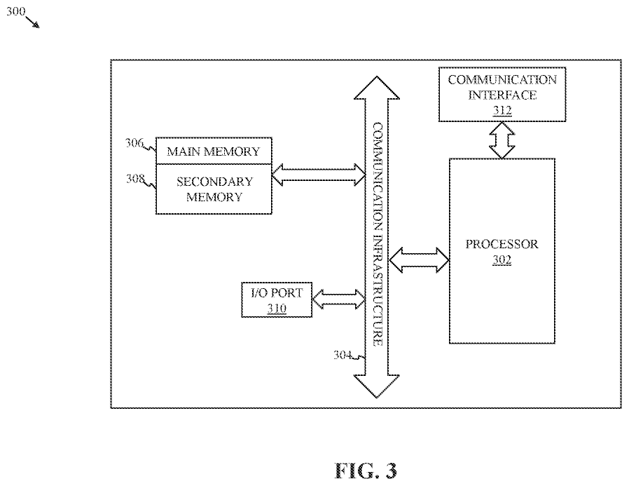

FIG. 3 is a block diagram that illustrates a system architecture of a computer system 300 for dynamic maintenance scheduling of a vehicle, in accordance with an exemplary embodiment of the disclosure. An embodiment of the disclosure, or portions thereof, may be implemented as computer readable code on the computer system 300. In one example, the application server 104 or the database server 106 of FIG. 1 may be implemented in the computer system 300 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIG. 3.

The computer system 300 may include a processor 302 that may be a special purpose or a general-purpose processing device. The processor 302 may be a single processor or multiple processors. The processor 302 may have one or more processor “cores.” Further, the processor 302 may be coupled to a communication infrastructure 304, such as a bus, a bridge, a message queue, the communication network 112, multi-core message-passing scheme, or the like. The computer system 300 may further include a main memory 306 and a secondary memory 308. Examples of the main memory 306 may include RAM, ROM, and the like. The secondary memory 308 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

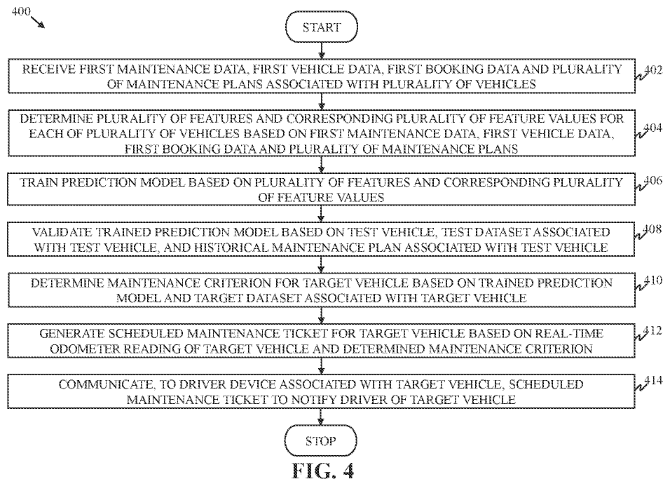

The computer system 300 may further include an input/output (I/O) port 310 and a communication interface 312. The I/O port 310 may include various input and output devices that are configured to communicate with the processor 302. Examples of the input devices may include a keyboard, a mouse, a joystick, a touchscreen, a microphone, and the like. Examples of the output devices may include a display screen, a speaker, headphones, and the like. The communication interface 312 may be configured to allow data to be transferred between the computer system 300 and various devices that are communicatively coupled to the computer system 300. Examples of the communication interface 312 may include a modem, a network interface, i.e., an Ethernet card, a communication port, and the like. Data transferred via the communication interface 312 may be signals, such as electronic, electromagnetic, optical, or other signals as will be apparent to a person skilled in the art. The signals may travel via a communications channel, such as the communication network 112, which may be configured to transmit the signals to the various devices that are communicatively coupled to the computer system 300. Examples of the communication channel may include a wired, wireless, and/or optical medium such as cable, fiber optics, a phone line, a cellular phone link, a radio frequency link, and the like. The main memory 306 and the secondary memory 308 may refer to non-transitory computer readable mediums that may provide data that enables the computer system 300 to implement the method illustrated in FIG. 4.

FIG. 4 is a flowchart 400 that illustrates a method for dynamic maintenance scheduling of a vehicle, in accordance with an exemplary embodiment of the disclosure.

At 402, the first maintenance data, the first vehicle data, the first booking data, and the plurality of maintenance plans associated with the plurality of vehicles 102a and 102b are received. The application server 104 may be configured to receive the first maintenance data, the first vehicle data, the first booking data, and the plurality of maintenance plans associated with the plurality of vehicles 102a and 102b. Each of the plurality of maintenance plans is indicative of one or more historical scheduled maintenance sessions of a corresponding vehicle of the plurality of vehicles 102a and 102b.

At 404, the plurality of features 212 and the corresponding plurality of feature values 214 for each of the plurality of vehicles 102a and 102b are determined based on the first maintenance data, the first vehicle data, the first booking data, and the plurality of maintenance plans. The application server 104 may be configured to determine the plurality of features 212 and the corresponding plurality of feature values 214 for each of the plurality of vehicles 102a and 102b based on the first maintenance data, the first vehicle data, the first booking data, and the plurality of maintenance plans.

At 406, the prediction model 210 is trained based on the plurality of features 212 and the corresponding plurality of feature values 214. The application server 104 may be configured to train the prediction model 210 based on the plurality of features 212 and the corresponding plurality of feature values 214.

At 408, the trained prediction model 210 is validated based on the test vehicle, the test dataset associated with the test vehicle, and the historic maintenance plan associated with the test vehicle. The application server 104 may be configured to validate the trained prediction model 210 based on the test vehicle, the test dataset associated with the test vehicle, and the historic maintenance plan associated with the test vehicle.

At 410, the maintenance criterion for the target vehicle 216 is determined based on the trained prediction model 210 and the target dataset associated with the target vehicle 216. The application server 104 may be configured to determine the maintenance criterion for the target vehicle 216 based on the trained prediction model 210 and the target dataset associated with the target vehicle 216. The target dataset includes the second maintenance data, the second vehicle data, and the second booking data associated with the target vehicle 216. The maintenance criterion indicates the odometer reading range of the target vehicle 216 during which the scheduled maintenance of the target vehicle 216 is to be performed.

At 412, the scheduled maintenance ticket for the target vehicle 216 is generated based on the real-time odometer reading of the target vehicle 216 and the determined maintenance criterion. The application server 104 may be configured to generate the scheduled maintenance ticket for the target vehicle 216 based on the real-time odometer reading of the target vehicle 216 and the determined maintenance criterion. The scheduled maintenance ticket is indicative of the date of the scheduled maintenance of the target vehicle 216, the time of the scheduled maintenance, the workshop name for the scheduled maintenance, and the workshop address for the scheduled maintenance.

At 414, the scheduled maintenance ticket is communicated to the driver device 218 associated with the target vehicle 216 to notify the driver of the target vehicle 216 regarding the scheduled maintenance.

Various embodiments of the disclosure provide the application server 104 for dynamic scheduling of maintenance of a vehicle. The application server 104 may be configured to receive the first maintenance data, the first vehicle data, the first booking data, and the plurality of maintenance plans associated with each vehicle 102a and 102b. Each of the plurality of maintenance plans is indicative of one or more historical scheduled maintenance sessions of a corresponding vehicle of the vehicles 102a and 102b. The application server 104 may be further configured to determine the plurality of features 212 and the corresponding plurality of feature values 214 for each of the vehicles 102a and 102b based on the first maintenance data, the first vehicle data, the first booking data, and the plurality of maintenance plans. The application server 104 may be further configured to train the prediction model 210 based on the plurality of features 212 and the corresponding plurality of feature values 214. The application server 104 may be further configured to validate the trained prediction model 210 based on the test vehicle, the test dataset associated with the test vehicle, and the historic maintenance plan associated with the test vehicle. The application server 104 may be further configured to determine the maintenance criterion for the target vehicle 216 based on the trained prediction model 210 and the target dataset associated with the target vehicle 216. The target dataset includes the second maintenance data, the second vehicle data, and the second booking data associated with the target vehicle 216. The maintenance criterion indicates the odometer reading range of the target vehicle 216 during which the scheduled maintenance of the target vehicle 216 is to be performed.

The application server 104 is further configured to generate the scheduled maintenance ticket for the target vehicle 216 based on the real-time odometer reading of the target vehicle 216 and the determined maintenance criterion. The scheduled maintenance ticket is indicative of the date of the scheduled maintenance of the target vehicle 216, the time of the scheduled maintenance, the workshop name for the scheduled maintenance, and the workshop address for the scheduled maintenance. The application server 104 is further configured to communicate to the driver device 218 associated with the target vehicle 216, the scheduled maintenance ticket to notify the driver of the target vehicle 216 regarding the scheduled maintenance.

Various embodiments of the disclosure provide a non-transitory computer readable medium having stored thereon, computer executable instructions, which when executed by a computer, cause the computer to execute one or more operations for dynamic scheduling of maintenance of a vehicle. The one or more operations include receiving the first maintenance data, the first vehicle data, the first booking data, and the plurality of maintenance plans associated with the vehicles 102a and 102b. Each of the plurality of maintenance plans is indicative of one or more historical scheduled maintenance sessions of a corresponding vehicle of the vehicles 102a and 102b. The one or more operations include determining the plurality of features 212 and the corresponding plurality of feature values 214 for each of the vehicles 102a and 102b based on the first maintenance data, the first vehicle data, the first booking data, and the plurality of maintenance plans. The one or more operations include training the prediction model 210 based on the plurality of features 212 and the corresponding plurality of feature values 214. The one or more operations include validating the trained prediction model 210 based on the test vehicle, the test dataset associated with the test vehicle, and the historic maintenance plan associated with the test vehicle. The one or more operations include determining the maintenance criterion for the target vehicle 216 based on the trained prediction model 210 and the target dataset associated with the target vehicle 216. The target dataset includes the second maintenance data, the second vehicle data, and the second booking data associated with the target vehicle 216. The maintenance criterion indicates an odometer reading range of the target vehicle 216 during which the scheduled maintenance of the target vehicle 216 is to be performed.

The one or more operations include generating a scheduled maintenance ticket for the target vehicle 216 based on the real-time odometer reading of the target vehicle 216 and the determined maintenance criterion. The scheduled maintenance ticket is indicative of the date of the scheduled maintenance of the target vehicle 216, the time of the scheduled maintenance, the workshop name for the scheduled maintenance, and the workshop address for the scheduled maintenance. The one or more operations further include communicating to the driver device 218 associated with the target vehicle 216, the scheduled maintenance ticket to notify the driver of the target vehicle 216 regarding the scheduled maintenance.

The disclosed embodiments encompass numerous advantages. Exemplary advantages of the disclosed methods include, but are not limited to, ensuring a timely maintenance of the target vehicle 216. Further, the disclosed methods and systems ensure that the scheduled maintenance is based upon a real-time health and performance of the target vehicle 216. The disclosed methods and systems allow for a significant improvement in use of resources, cost, time, and effort required for maintenance of the target vehicle 216. Further, the disclosed methods and systems prevent the target vehicle 216 from non-scheduled maintenance that disrupts a working schedule of the target vehicle 216 and its driver. The disclosed methods and systems further ensure longevity and good health of the target vehicle 216. Therefore, the disclosed methods and systems ensure that the target vehicle 216 consistently provides an efficient performance. Further, the disclosed methods and systems ensure that the target vehicle 216 is maintained prior to suffering from any performance issues, thereby preventing any unexpected break down of the target vehicle 216. Hence, the disclosed methods and systems prevent the driver of the vehicle 102a from an unexpected financial loss and emotional despair due to the unexpected break down caused to the target vehicle 216. Further, the disclosed methods and systems determine an odometer reading range for maintenance of the target vehicle 216. Therefore, planning the maintenance becomes convenient for the driver. Further, the disclosed methods and systems may be used by a vehicle aggregator, a transportation service provider, an individual owner, and the like. In contrast to conventional techniques where the maintenance is scheduled based on distance travelled by a vehicle, the technological advancements in the application server 104 allows to leverage real-time health and performance of the target vehicle 216 for dynamic scheduling of maintenance of the target vehicle 216.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems and methods for dynamic maintenance scheduling for vehicles. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A dynamic maintenance scheduling method, comprising:
receiving, by a server, first maintenance data, first vehicle data, first booking data, and a plurality of maintenance plans associated with a plurality of vehicles, wherein each of the plurality of maintenance plans is indicative of one or more historical scheduled maintenance sessions of a corresponding vehicle of the plurality of vehicles;
determining, by the server, a plurality of features and a corresponding plurality of feature values for each of the plurality of vehicles based on the first maintenance data, the first vehicle data, the first booking data, and the plurality of maintenance plans;
training, by the server, a prediction model based on the plurality of features and the corresponding plurality of feature values; and
determining, by the server, a maintenance criterion for a target vehicle based on the trained prediction model and a target dataset associated with the target vehicle, wherein the target dataset includes second maintenance data, second vehicle data, and second booking data associated with the target vehicle, and wherein the maintenance criterion indicates at least an odometer reading range of the target vehicle during which a scheduled maintenance of the target vehicle is to be performed.

2. The dynamic maintenance scheduling method of claim 1, further comprising generating, by the server, a scheduled maintenance ticket for the target vehicle based on a real-time odometer reading of the target vehicle and the determined maintenance criterion, wherein the scheduled maintenance ticket is indicative of at least one of a date of the scheduled maintenance of the target vehicle, a time of the scheduled maintenance, a workshop name for the scheduled maintenance, and a workshop address for the scheduled maintenance.

3. The dynamic maintenance scheduling method of claim 1, further comprising communicating, by the server, to a driver device associated with the target vehicle, the scheduled maintenance ticket to notify a driver of the target vehicle regarding the scheduled maintenance.

4. The dynamic maintenance scheduling method of claim 1, further comprising validating, by the server, the trained prediction model based on a test vehicle, a test dataset associated with the test vehicle, and a historic maintenance plan associated with the test vehicle.

5. The dynamic maintenance scheduling method of claim 1, wherein the plurality of features include a mean time between consecutive failures of a vehicle.

6. The dynamic maintenance scheduling method of claim 1, wherein the plurality of features include at least two or more of a count of non-scheduled maintenance sessions of a vehicle, a count of repairs of a vehicle, a count of major accidents of a vehicle, or a unit distance travelled by a vehicle between consecutive maintenance sessions in past.

7. The dynamic maintenance scheduling method of claim 1, wherein the plurality of features include at least two or more of a count of non-scheduled repairs of a vehicle, a maintenance cost of a vehicle, a cost incurred due to accidents of a vehicle, a repair downtime of a vehicle, an average cost incurred for historical maintenance sessions of a vehicle, a frequency of maintenance sessions of a vehicle, or a deviation in a frequency of maintenance sessions of a vehicle.

8. The dynamic maintenance scheduling method of claim 1, wherein the plurality of features include a cost per unit distance forecasted for one or more components of a vehicle and an asset health index of a vehicle.

9. The dynamic maintenance scheduling method of claim 1, wherein the plurality of features include at least two or more of a count of dormant days of a vehicle, a count of active days of a vehicle, or a deviation in a count of active days between consecutive scheduled maintenance sessions of a vehicle.

10. The dynamic maintenance scheduling method of claim 1, wherein the plurality of features include at least two or more of a dry run distance travelled by a vehicle, a trip run distance travelled by a vehicle, an excess run distance travelled by a vehicle, a total distance travelled per day by a vehicle, or an average total distance travelled per day by a vehicle.

11. The dynamic maintenance scheduling method of claim 1, wherein the plurality of features include at least two or more of a vehicle make, a vehicle model, a region of operation of a vehicle, an age of a vehicle, a fuel type of a vehicle, a count of unique drivers of a vehicle, or an odometer reading of a vehicle.

12. A dynamic maintenance scheduling system, comprising:
a server configured to:
receive first maintenance data, first vehicle data, first booking data, and a plurality of maintenance plans associated with a plurality of vehicles, wherein each of the plurality of maintenance plans is indicative of one or more historical scheduled maintenance sessions of a corresponding vehicle of the plurality of vehicles;
determine a plurality of features and a corresponding plurality of feature values for each of the plurality of vehicles based on the first maintenance data, the first vehicle data, the first booking data, and the plurality of maintenance plans;
train a prediction model based on the plurality of features and the corresponding plurality of feature values; and
determine a maintenance criterion for a target vehicle based on the trained prediction model and a target dataset associated with the target vehicle, wherein the target dataset includes second maintenance data, second vehicle data, and second booking data associated with the target vehicle, and wherein the maintenance criterion indicates at least an odometer reading range of the target vehicle during which a scheduled maintenance of the target vehicle is to be performed.

13. The dynamic maintenance scheduling system of claim 12, wherein the server is further configured to generate a scheduled maintenance ticket for the target vehicle based on a real-time odometer reading of the target vehicle and the determined maintenance criterion, wherein the scheduled maintenance ticket is indicative of at least one of a date of the scheduled maintenance of the target vehicle, a time of the scheduled maintenance, a workshop name for the scheduled maintenance, and a workshop address for the scheduled maintenance.

14. The dynamic maintenance scheduling system of claim 12, wherein the server is further configured to communicate, to a driver device associated with the target vehicle, the scheduled maintenance ticket to notify a driver of the target vehicle with regards to the scheduled maintenance.

15. The dynamic maintenance scheduling system of claim 12, wherein the server is further configured to validate the trained prediction model based on a test vehicle, a test dataset associated with the test vehicle, and a historic maintenance plan associated with the test vehicle.

16. The dynamic maintenance scheduling system of claim 12, wherein the plurality of features include a mean time between consecutive failures of a vehicle.

17. The dynamic maintenance scheduling system of claim 12, wherein the plurality of features include at least two or more of a count of non-scheduled maintenance sessions of a vehicle, a count of repairs of a vehicle, a count of major accidents of a vehicle, a unit distance travelled by a vehicle between consecutive maintenance sessions in past, a count of non-scheduled repairs of a vehicle, a maintenance cost of a vehicle, a cost incurred due to accidents of a vehicle, a repair downtime of a vehicle, an average cost incurred for historical maintenance sessions of a vehicle, a frequency of maintenance sessions of a vehicle, or a deviation in a frequency of maintenance sessions of a vehicle.

18. The dynamic maintenance scheduling system of claim 12, wherein the plurality of features include at least two or more of a count of dormant days of a vehicle, a count of active days of a vehicle, or a deviation in a count of active days between consecutive scheduled maintenance sessions of a vehicle.

19. The dynamic maintenance scheduling system of claim 12, wherein the plurality of features include at least two or more of a dry run distance travelled by a vehicle, a trip run distance travelled by a vehicle, an excess run distance travelled by a vehicle, a total distance travelled per day by a vehicle, or an average total distance travelled per day by a vehicle.

20. The dynamic maintenance scheduling system of claim 12, wherein the plurality of features include at least two or more of a vehicle make, a vehicle model, a region of operation of a vehicle, an age of a vehicle, a fuel type of a vehicle, a count of unique drivers of a vehicle, or an odometer reading of a vehicle.
